(19) United States
(12) Patent Application Publication
(10) Pub. No.: US 2015/0083337 A1
(43) Pub. Date: Mar. 26, 2015

(54) LABELING APPARATUS INCLUDING SPRING-LOADED APPLICATORS

(71) Applicant: NuLabel Technologies, Inc., East Providence, RI (US)

(72) Inventors: Randy Peckham, North Scituate, RI (US); Michael Medeiros, Plainville, MA (US); Jason A. Meek, Pawtucket, RI (US); Michael C. Woods, Rumford, RI (US); Benjamin David Lux, Providence, RI (US); Andrew W. Marsella, Providence, RI (US)

(21) Appl. No.: 14/498,981

(22) Filed: Sep. 26, 2014

Related U.S. Application Data
(60) Provisional application No. 61/883,098, filed on Sep. 26, 2013.

(51) Int. Cl. B65C 3/16; B65C 9/40; B65C 9/30; B65C 9/14; B65C 9/22

(52) U.S. Cl. CPC B65C 3/16; B65C 9/14; B65C 9/22; B65C 9/30; B65C 9/40
USPC 156/378; 156/578; 156/570

(57) ABSTRACT

An apparatus and method is described herein for applying labels to containers. The apparatus includes a guidance mechanism configured to provide a path for receiving a plurality of labels having a back surface with a fluid activatable adhesive that is non-tacky until activated, an adhesive activation station aligned with at least a portion of the guidance mechanism and configured to apply to the back surface of said labels a fluid to activate said adhesive along said back surface of said labels, and a label application station configured to apply at least one of said labels with said activated adhesive onto an exterior surface of a corresponding object located on a rotatable platform. The guidance mechanism includes at least one rotatable transfer member having a plurality of pallets. Each of the pallets includes multiple openings for communication of suction to enable at least one of the pallets to receive and releasably secure a front of the labels onto at least one pallet, and one or more rollers connected to each of the pallets by one or more tunable complaint members. The label application station includes a servo motor configured to drive a linear speed and a rotational direction of the platform.

### CROSS-REFERENCE TO RELATED APPLICATIONS

This application claims priority to U.S. Application Ser. No. 61/883,098, filed on Sep. 26, 2013 and entitled “BOTTLE LABEL ROLLER APPLICATOR,” the contents of which is hereby incorporated by reference in its entirety.

### TECHNICAL FIELD

An automated labeling apparatus and methods are described herein. More particularly, an automated labeling apparatus and method for applying labels having fluid activatable adhesive onto containers, such as containers, cans, or jars using spring-loaded applicators is described herein.

### BACKGROUND

For over 50 years, automated machines have been used to apply labels onto containers, such as bottles, cans or jars. Typically these machines utilize cold glue or hot melt adhesives which are applied by a roller onto a pad prior to pickup and then the labels are transferred onto another pad or drum which in turn applies it to a container. Conventional automated labeling machines include those manufactured by Krones AG in Germany or Krones, Inc. in Franklin Wis. (Krones AG and Krones, Inc., being referred to herein as “Krones”).

### SUMMARY

An automated labeling apparatus and methods include a spring-loaded applicator that, in response to contact of a container with the spring-loaded applicator, exerts a force against the container to assist in joining a label with an activated adhesive to the outer surface of the container is described herein. More particularly, a spring-loaded applicator having a conformable surface and a tunable force application is described herein. The automated labeling apparatus and methods provide a greater contact area between the apparatus and the label while the label is being placed on a container by using a spring-loaded applicator that applies a customizable or tunable force against the label. The automated labeling apparatus and methods also reduce scuffing and skimming on a label through variable speed matching capabilities.

The details of one or more embodiments of the invention are set forth in the accompanying drawings and the description below. Other features, objects, and advantages of the invention will be apparent from the description and drawings, and from the claims.

In one aspect, an apparatus for applying labels to containers, includes a guidance mechanism configured to provide a path for receiving a plurality of labels having a back surface with a fluid activatable adhesive that is non-tacky until activated. The guidance mechanism including at least one rotatable transfer member having a plurality of pallets. Each of the pallets has multiple openings for communication of suction to enable at least one of the pallets to receive and releasably secure a front of the labels onto at least one pallet, and one or more rollers connected to each of the pallets by one or more tunable complaint members. The apparatus also includes an adhesive activation station aligned with at least a portion of the guidance mechanism and configured to apply to the back surface of said labels a fluid to activate said adhesive along said back surface of said labels, and a label application station configured to apply at least one of said labels with said activated adhesive onto an exterior surface of a corresponding object located on a rotatable platform, wherein the label application station includes a servo motor configured to drive a linear speed and a rotational direction of the platform.

In another aspect, an apparatus for applying labels to containers, the apparatus includes a guidance mechanism configured to provide a path for receiving a plurality of labels having a back surface with a fluid activatable adhesive that is non-tacky until activated, the guidance mechanism including at least one rotatable transfer member having a plurality of pallets. Each of the pallets has a first applicator including a first roller mechanism and connected to the transfer member; a second applicator including a second roller mechanism and connected to the first applicator; and one or more tunable-complaint members connected to the first applicator, to the second applicator, and to the transfer member; multiple openings for communication of suction to enable at least one of the pallets to receive and releasably secure a front of the labels onto at least one pallet, and one or more rollers connected to each of the pallets by one or more by one or more tunable-complaint members. The apparatus also includes an adhesive activation station aligned with at least a portion of the guidance mechanism and configured to apply to the back surface of said labels a fluid to activate said adhesive along said back surface of said labels; and a label application station configured to apply said labels with said activated adhesive onto an exterior surface of a corresponding object located on a rotatable platform, wherein the label application station includes a servo motor configured to drive a linear speed and a rotational direction of the platform.

Implementations can include one or more of the following features.

In some implementations, the apparatus further includes a dispensing magazine for retaining a plurality of individual labels in a stack and a second rotating transfer member arranged in close proximity to individual labels and including at least one pallet thereon, the at least one pallet having multiple openings for communication of suction to enable the second rotating transfer member to receive and releasably secure a front of the labels onto the at least one pallet.

In certain implementations, the second rotating transfer member further comprises one or more valves to selectively control communication of suction to a selected subset of the multiple openings based on a size of the label, each of the valves being associated with a particular one of the multiple openings.

In some implementations, the apparatus further includes: one or more sensors for sensing the linear speed, the rotational direction, or both the linear speed and rotational direction of the rotatable transfer member and of the rotatable platform; and a controller configured to control the servo motor in response to the sensors.

In certain implementations, the one or more tunable complaint members is one or more springs.

In some implementations, the one or more rollers are arranged to form a concave surface on each of the pallets.

In certain implementations, the rotatable platform rotates at a linear first speed and the rotatable transfer member rotates at a linear second speed.

In some implementations, a length of the one or more rollers at least as long as a longest length of the labels.

In some implementations, each pallet includes a plurality of rollers connected to each of the pallets by one or more tunable-complaint members, wherein the plurality of rollers are arranged in at least two rows.

In certain implementations, each of the one or more rollers independently connects to the pallets by one or more by one or more tunable-complaint members.

In some implementations, a force exerted by the one or more by one or more tunable-complaint members is variable.

In certain implementations, the apparatus further includes a container-handling device for receiving containers at an inlet, rotating the containers on the rotatable platform through the label application station, and directing the containers with the labels applied thereon to an outlet.

In some implementations, the at least one rotating transfer member further comprises one or more valves, each of the valves being associated with a particular one of the multiple openings, to selectively control communication of suction to a selected subset of the multiple openings based on the size of the label.

In certain implementations, the one or more rollers are configured to apply a force to about 50% of a surface of the label.

In some implementations, the apparatus further includes a dispensing magazine for retaining a plurality of individual labels in a stack and a second rotating transfer member arranged in close proximity to individual labels and including at least one pallet thereon, the at least one pallet having multiple openings for communication of suction to enable the second rotating transfer member to receive and releasably secure a front of the labels onto the at least one pallet.

In certain implementations, the second rotating transfer member further includes one or more valves to selectively control communication of suction to a selected subset of the multiple openings based on the size of the label, each of the valves being associated with a particular one of the multiple openings.

In some implementations, the apparatus further includes one or more sensors for sensing of the linear speed, the rotational direction, or both the linear speed and rotational direction of the rotatable transfer member and of the rotatable platform; and a controller configured to control the servo motor in response to the sensors.

In certain implementations, the first applicator is configured to apply a leading edge of the label to the container and the second applicator is configured to remove complete the label application.

In some implementations, the one or more tunable-complaint members are springs.

In certain implementations, the rotatable platform rotates at a linear first speed and the rotatable transfer member rotates at a linear second speed.

In some implementations, the force exerted by the one or more by one or more tunable-complaint members is variable between the first applicator and the second applicator.

In certain implementations, the apparatus further includes a container-handling device for receiving containers at an inlet, rotating the containers on the rotatable platform through the label application station, and directing the containers with the labels applied thereon to an outlet.

In some implementations, the at least one rotating transfer member further comprises one or more valves, each of the valves being associated with a particular one of the multiple openings, to selectively control communication of suction to a selected subset of the multiple openings based on the size of the label.

In certain implementations, the one or more rollers are configured to apply a force to about 50% of a surface of the label.

In some implementations, further includes a spring-return cam mechanism attached to first roller mechanism and the second roller mechanism.

### DESCRIPTION OF DRAWINGS

The foregoing and other objects, features, and advantages of the disclosure will become more apparent from a reading of the following description in connection with the accompanying drawings in which:

FIG. 1 is a schematic view illustrating a labeling apparatus.

FIG. 2A is the perspective view of the apparatus of FIG. 1.

FIG. 2B is same perspective view as FIG. 2A with the first rotating transfer member partially broken to show the adhesive activation station along the second rotating transfer station.

FIG. 3A is a perspective view of a portion of the labeling apparatus of FIG. 1 including the transfer pallets of FIG. 5.

FIG. 3B is a perspective view of a portion of the labeling apparatus of FIG. 1 including the transfer pallets of FIGS. 7A-7B.

FIG. 4 is cross-sectional view of one of the labels of FIG. 1.

FIG. 5 is a perspective view of one of the transfer pallets compatible with of FIG. 1.

FIG. 6 is a perspective view of one of the pallets mounted to the first rotating transfer member of FIG. 1.

FIG. 7A is a side view of one of the transfer pallets compatible with of FIG. 1.

FIG. 7B is a perspective view of one of the transfer pallets including rows of individually spring-loaded rollers.

FIGS. 8A-8E are schematic views showing the relative motion of a bottle (not shown) passing through the applicator pallet, which includes a plurality of rollers.

FIG. 9 is a perspective view of one of the pallets of FIG. 1 showing the application of a label to a bottle.

FIG. 10A is a perspective view of a transfer pallet configured for applying a label to a narrow container.

FIG. 10B is a perspective view of the pallet of FIG. 10A retaining a label.

FIG. 10C is a perspective view of the pallet of FIG. 10B applying the label to a bottle 20.

FIG. 11 is a perspective view of a multiple transfer pallets of FIG. 10A mounted to the first rotating transfer member of FIG. 1.

FIGS. 12A-C are perspective views of a transfer pallet configured for applying a label to a narrow container.

FIGS. 13A-13E are perspective views of the transfer pallet of FIG. 12B and various bottle shapes.

### DETAILED DESCRIPTION

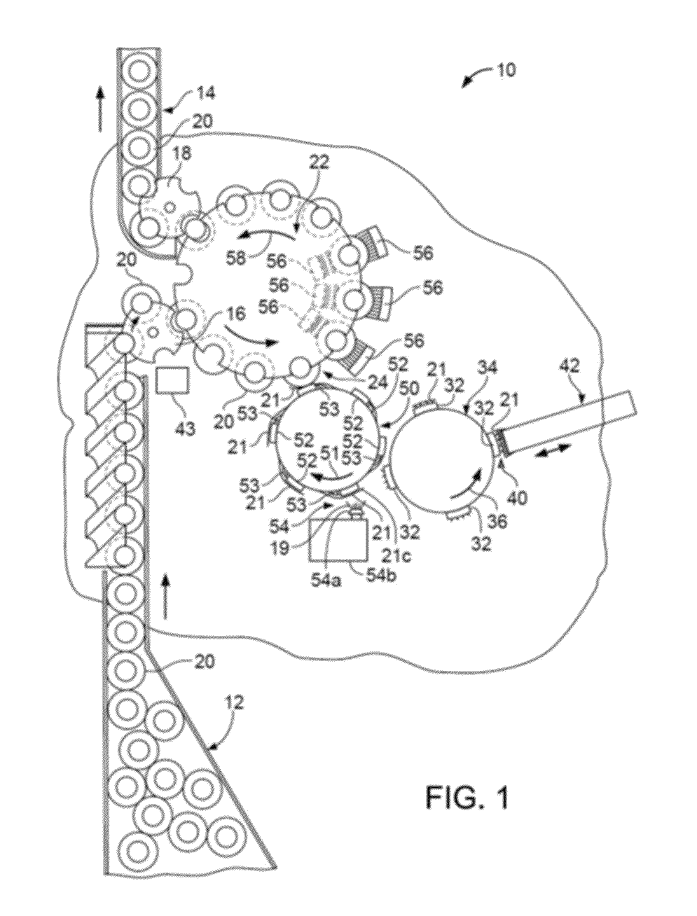

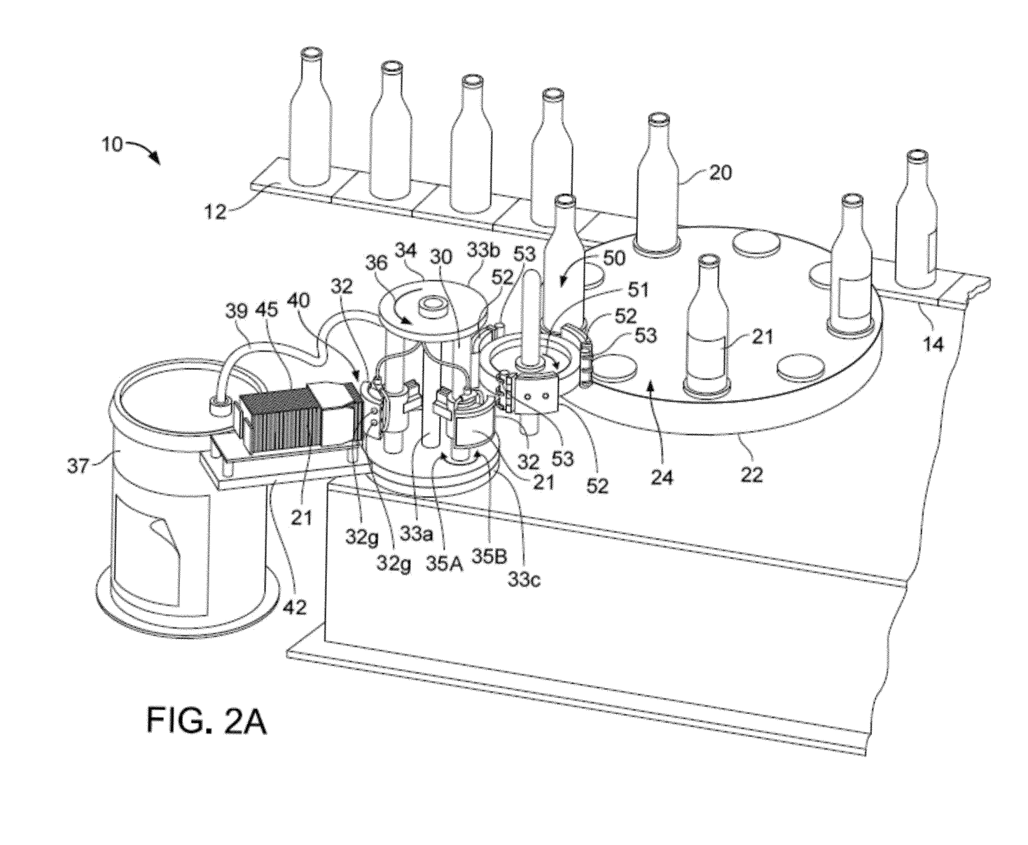

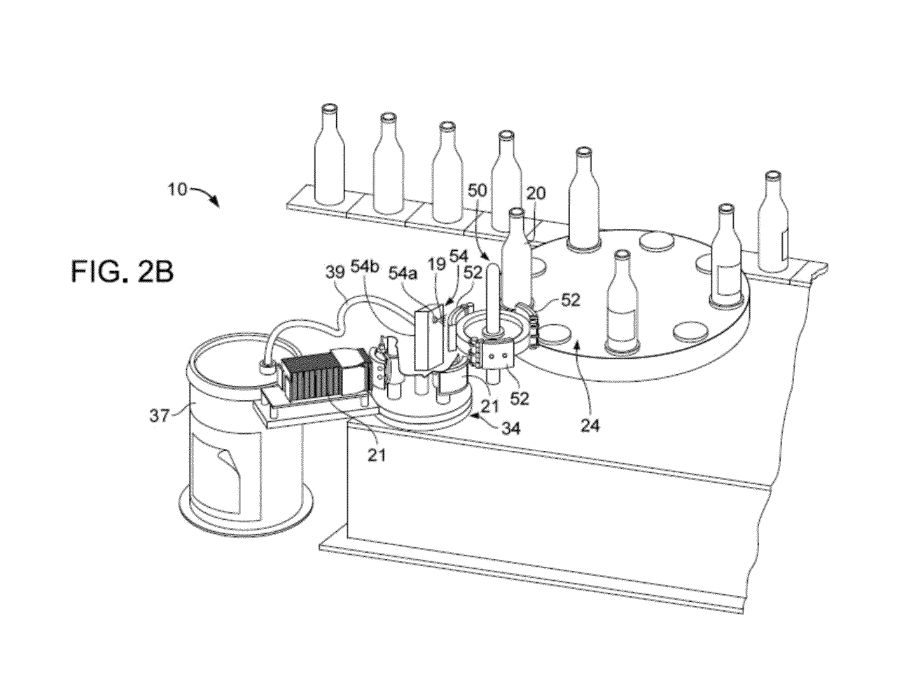

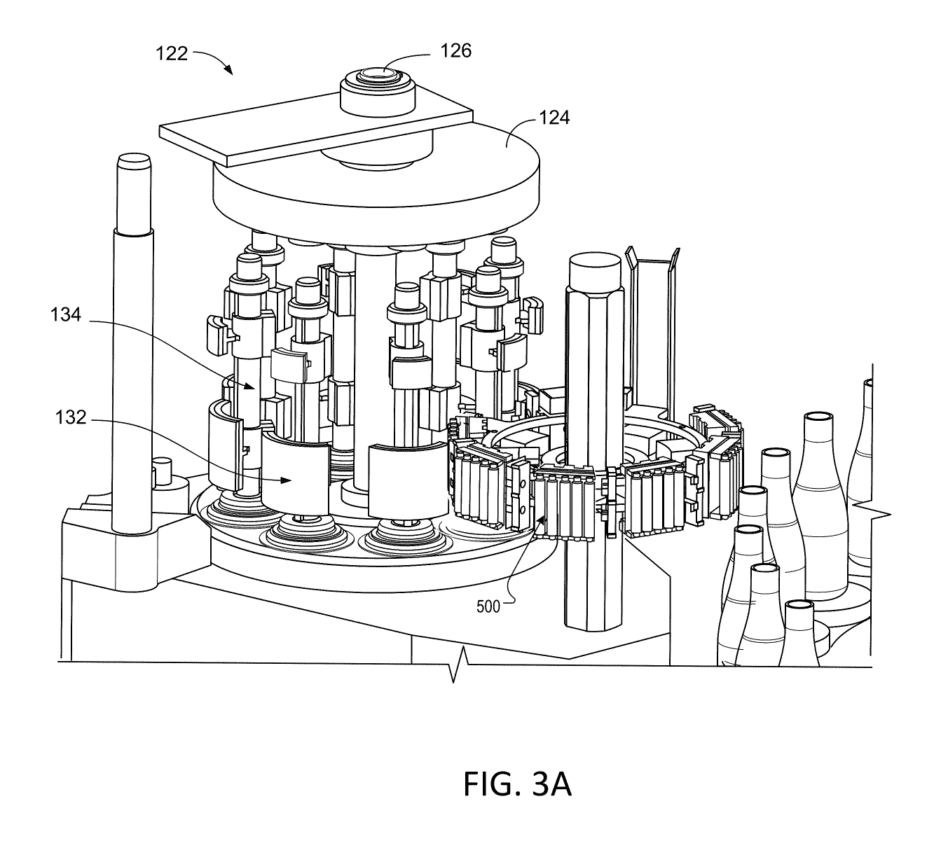

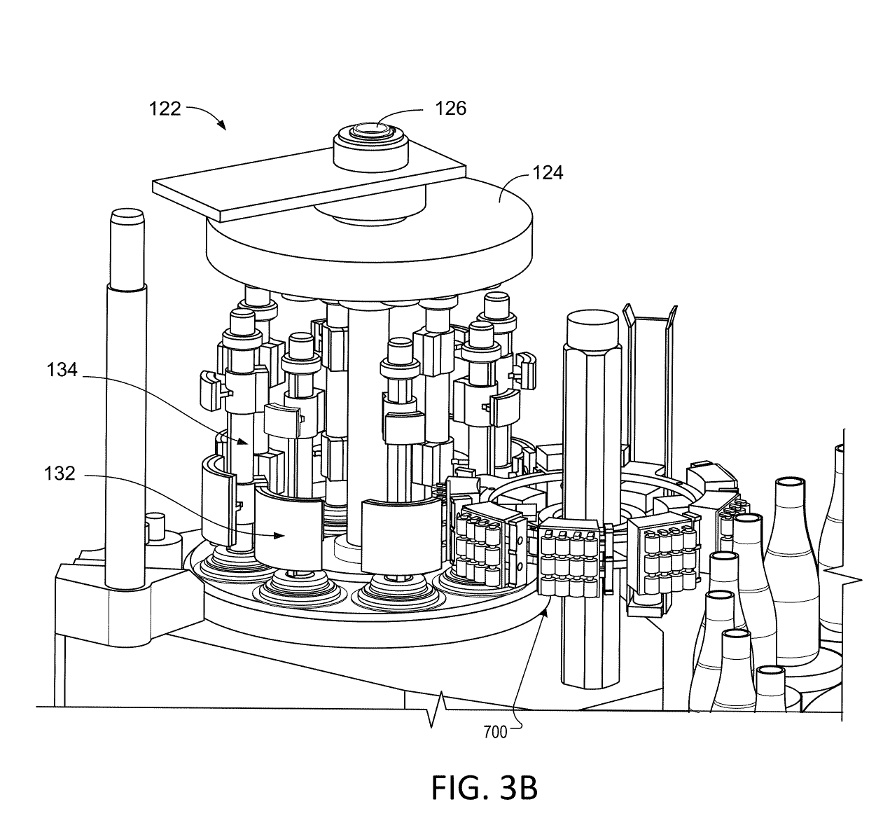

Referring to FIGS. 1, 2A, 2B, and 3A-B, an apparatus 10 for automatically applying labels to containers is shown Apparatus 10 employs an inlet conveyor section 12, an outlet conveyor section 14 and rotating bottle-transfer members 16 and 18 for transferring bottles 20 from the inlet conveyor section to a rotating platform or turret 22, and also for removing bottles 20 from the rotating turret 22 to the outlet conveyor section 14, respectively, after the bottles have been directed through label application station 24. However, in some embodiments an in-line system that does not require the use of a rotating turret to handle the bottles, or other containers, during the label application operation can be used. Bottle-transfer members 16 and 18 are not shown in FIGS. 2A and 2B for purposes of illustration.

It should be understood that the construction of the inlet conveyor section 12, the outlet conveyor section 14, the inlet-rotating member 16, the outlet-rotating member 18, and the rotating turret 22 would be apparent to one of ordinary skill in the art. For example, Krones manufactures a line of rotary labeling equipment including the inlet conveyor section 12, the outlet conveyor section 14, the rotating container-transfer members 16 and 18, and the rotating turret 22 of the type that can be employed in the present systems and methods. Therefore, a detailed discussion of these features is not required herein.

The apparatus 10 also includes two transfer members 34 and 51 that are used to transfer a label from a magazine 42 that retains a stack 45 of labels to the bottles 20. More particularly, during use, the first rotating transfer member 34 uses a suction based pallet (e.g., a transfer pallet 32) to remove a non-activated label from the magazine 42 and transfer the label to a pallet on the second rotating transfer member 51. Once the label is secured on the second rotating member, the label is removed from the transfer pallet 32 on the first rotating member and vacuum flow through the openings in the first pallet ceases based on the automatic vacuum modulation mechanism described above in relation to FIGS. 1, 2A-B, and 3A-B.

Subsequently, a fluid is applied by an adhesive activation station 54 and the activated label is then applied to the bottle.

More particularly, multiple transfer pallets 32 are mounted on the first rotating transfer member 34 (rotated in the direction of arrow 36) through support shafts 33a mounted for oscillatory motion relative to the support shaft (as represented by the arrows 35 and 35A). The transfer member 34 rotates along a shaft 33a and along a pair of mounting plates 33a and 33. A support shaft 33a extends between the mounting plates 33a and 33. This oscillatory motion is provided by a cam drive arrangement. Exemplary cam drive arrangements for rotating a transfer member are known to those skilled in the art.

In the one example, transfer pallets 32 are oscillated in the counterclockwise direction of arrow 35A, as viewed in FIG. 2A. Transfer pallets 32 are directed sequentially by the rotating transfer member 34 to a transfer station 40. The transfer station 40 includes a magazine 42 retaining a stack 45 of the labels 21, which are pre-cut, therein. A label is transferred from the transfer station 40 by application of a vacuum to the transfer pallet 32. More particularly, contact between suction cups on the pallet and the label cause the plunger to be depressed and a vacuum to be applied to a vacuum cup on the transfer pallet 32 to retain the label on the transfer pallet 32. The label continues to be retained on the transfer pallet 32 during rotation of the transfer member 34 by continued application of the vacuum. In some examples, any linear movement or rotation In some examples, a motor (e.g. a servo motor) causes the linear movement or rotation of the components described herein.

As shown in FIGS. 2A-2B, the transfer pallets 32 with the labels 21 thereon are then rotated by the first rotating transfer member 34 to a second rotating transfer member 50 (rotated in the direction of arrow 51). This second rotating transfer member 50 has a plurality of applicator pallets 52. Each applicator pallet has a cam operated label retaining (or gripping) members or fingers 53 disposed about the periphery thereof for engaging the label 21 carried by the transfer pallets 32 and transferring the labels to the second rotating transfer member 50. Each of the retaining members 53 grip in order to receive upon its associated applicator pallets 52 the labels 21 carried on the transfer pallets 32. The retaining members are configured, e.g., timed, for release upon the application of compression. In this case, the compression of the rollers on the container will trigger the release of the label so that he label may move freely. Later, at label application station 24, the retaining members 53 are positioned to release labels. During the transfer of the labels to the second rotating transfer member 50, the transfer pallets 32 are oscillated in the counterclockwise direction of arrow 35A, as viewed in FIG. 2A.

While in the example described above in relation to FIGS. 2A-2B, the label is secured to the second rotating transfer member 50 by label retaining (or gripping) members or fingers 53 disposed about the periphery thereof for engaging the labels 21, other methods can be used to secure the labels to the second rotating transfer member. For example, the applicator pallet 52 can include a suction based pallet for securing the labels. In such arrangements, the label is transferred by application of a vacuum to the applicator pallet 52. In this case, the applicator pallet 52 continues to retain the label 21 during rotation of the second rotating transfer member 50 by continued application of the vacuum. More particularly, the applicator pallet 52 includes one or more holes (or openings) along the back surface. One or more of these holes are in communication with a vacuum source. As such, a vacuum can be applied through the transfer pallet (e.g., through one or more rollers to retain the label 21 during the rotation of the second rotating transfer member). The size, number, and location of the holes or openings can vary based on the size and weight of the labels to be applied by the apparatus 10.

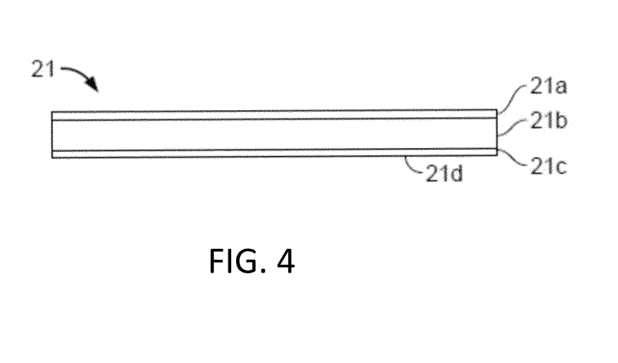

As shown in FIG. 4, each label (or media) 21 has a printable layer 21a formed on the front side of a stock, media, or facesheet 21b, and a back side 21c with a solvent (fluid) sensitive adhesive agent layer 21d (such as a polymer type adhesive) which possesses no tack in its dry or non-activated state. Layer 21d enables label 21 to become tacky along its back side layer 21d becomes tacky upon application of activation fluid 19, which is supplied at adhesive activation station 54, as described later below. One the adhesive is activated, this enables the label to adhere along its back surface to a variety of article surfaces, such as paper, cardboard, metal, as well as glass and plastics. In the example of FIG. 1, the bottle 20 in the case of bottles may be glass or plastic. Exemplary liner-free labels 21 and activating fluid 19 activation fluid 19 are described in U.S. Pat. No. 8,334,336 titled “Fluid Activatable Adhesives and Fluids for Activating Same for Use with Liner-Free Labels” and U.S. Pat. No. 8,334,335 titled “Fluid Activatable Adhesives and Fluids for Activating Same for Use with Liner-Free Labels”, the contents of each of which are hereby incorporated by reference in their entirety. The printable layer 21a may be a pre-printed layer of ink(s) providing the desired label for container 20 bottle 20 as typical of labels applied to containers. Typically, all labels in the stack 45 are identical for a given set of bottle 20 being processed by the apparatus 10.

Referring again to FIGS. 1, 2A, 2B, and 3, the second rotary transfer member 50, with labels 21 thereon, is directed through an adhesive activation station 54 in order to change the a solvent sensitive adhesive agent layer 21d to a tacky state so as to permit the label to be securely and effectively adhered to the outer surface of a bottle 20 along its back side 21c (preferably a curved outer surface of a bottle, where presented thereto at label application station 24).

As shown in FIG. 1 and FIG. 2B, adhesive activation station 54 has one or more fluid dispensing mechanisms (e.g., sprayer 54a) for application of the pressurized activation fluid 19 onto labels 21. The activation fluid can be a combination of one or more solvents, such as water and/or low boiling point alcohols. In some examples, the activation fluid does not contain any suspended or dissolved solids in the liquid (e.g., the fluid is a blend of one or more neat drying solvents and/or water) and only contains solvents. In some examples, the solvents can have low enough vapor pressures so that they can evaporate in room temperature environmental conditions. By utilizing volatile solvents and including no suspended solids in the activation fluid, any liquid that is released and not applied to the labels (overspray) will dry cleanly, thereby reducing cleanup and maintenance of the apparatus 10. Each of the one or more sprayers 54a may be a nozzle with a valve that is held in a fixture 54b (depicted schematically as a block in FIGS. 1 and 4B). Each nozzle receives activation fluid 19 via a tube 39 from a source of such fluid, as depicted by container 37 in FIGS. 2A and 2B. The nozzle's valve is actuated when needed to apply activation fluid 19 to wet label 21 as it moves through the adhesive activation station 54. The timing of spraying of activation fluid 19 for different run speeds of apparatus 10 is enabled by a control system. For example, the nozzle of each of the one or more sprayers 54a may be an air-assisted nozzle, however, any sprayer mechanism may be used so that an adequate amount of activation fluid 19 is sprayed on the label 21 which moves with respect to the fixed adhesive activation station 54. For example, the fluid dispensing mechanisms can include an array of one or multiple fan or cone nozzles controlled by valves, an array of one or multiple air-assisted fan or cone nozzles controlled by valves, and/or an inkjet-type spray head.

Each of the sprayers 54a provides a fan pattern aligned with the height of the label 21 as it is rotated along upon the applicator pallet 52 and held thereto by retaining members 53. Thus, the activation fluid is provided directly from the sprayers 54a onto the label. Preferably, multiple fluid sprayers 54a are provided to obtain the desired surface coverage of the label with activation fluid 19 as it moves through the adhesive activation station 54. In one particular example, when two nozzles are used, each nozzle produces a stream having fan shape (e.g., an approximately 2 inch fan shape), and together they activate a label which is 4 inches in height to deliver a uniform layer of activation fluid 19. Sprayers 54a are aligned in a vertical dimension parallel to the height of label 21, where the sprayers are at a distance from the label 21 to direct fluid coverage over the entire back side (or at least substantially the entire back side of the label 21 (e.g., covering greater than 90% of the back surface.) of the label 21. In some cases, the sprayers direct fluid coverage over a surface area to assure label adhesiveness later at label application station 24. The flow rate out of the nozzle varies depending on label speed to produce a desired activation fluid 19 deposition rate, such as 0.15 g per 24 square inches. In another example, a single sprayer 54a provides a spray pattern sufficient with the height of the label.

In this manner, the second rotating transfer member 50 directs the labels held upon the applicator pallets 52 through an adhesive activation station 54 in order to apply a activation fluid 19 for activating adhesive along each the back surface 21c of the label 21. This fluid will change the adhesive's layer 21d from a non-tacky state to a tacky state just before application of the label to a container at label application station 24. For example, the fluid activatable adhesive is only tacky to permit the label to be adhered to the outer surface of the container at a location closely adjacent the label application station 24.

Still referring to FIG. 1, each of the labels 21 is directed from the adhesive activation station 54 with the adhesive thereon being in a tacky condition to uniformly and effectively adhere the labels 21 to a container. The label is then immediately rotated into a position for engaging the outer periphery of a bottle 20 carried on the turret 22 in the label application station 24. It should be noted that the spacing of the labels on the second rotating transfer member 50 and the speed of rotation of the transfer assembly are timed with the speed of rotation of the rotating turret 22 such that each label carried on the second rotating transfer member 50 is sequentially directed into engagement with an adjacent bottle carried on the rotating turret. Moreover, the photo detection system 43 prevents a label from being carried to the label application station 24 when a bottle for receiving such label is missing from that station.

Each of the labels 21 is applied to the bottle 20 essentially at its midline to a periphery of the bottle 20 that is adjacent, thereby providing outer wings extending in opposed directions from the center line of the label, which is adhered to the bottle. The applicator pallet 52 is actuated forward by a cam mechanism at the label application station 24 with respect to bottle 20 to receive the label from the applicator pallet 52.

The applicator pallet 52 can be arranged in multiple configurations, as described below.

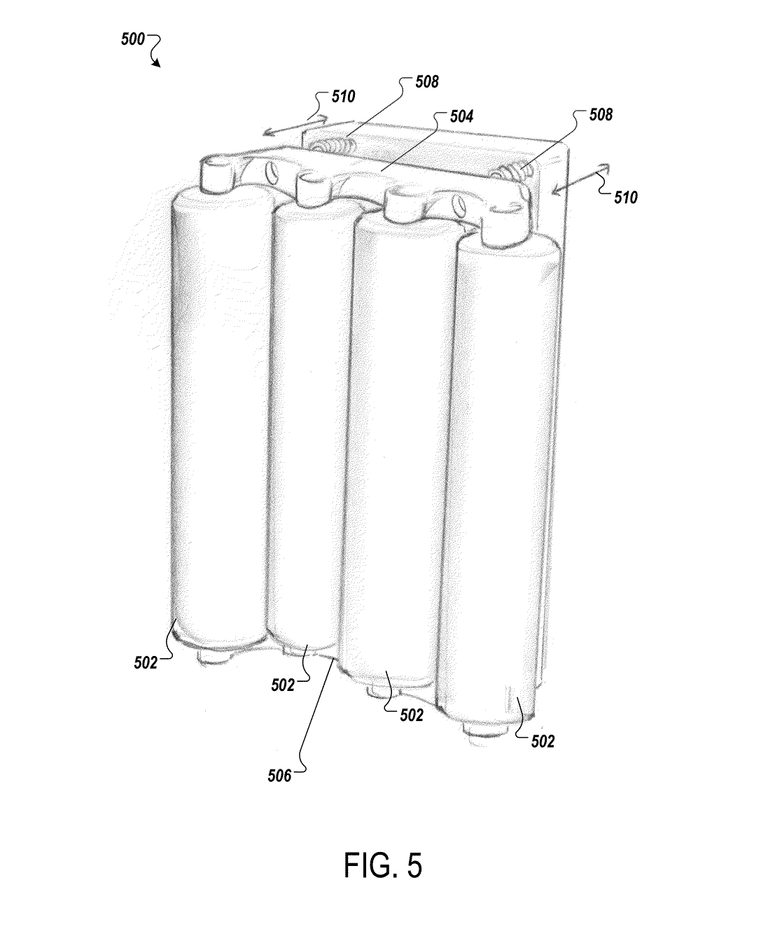

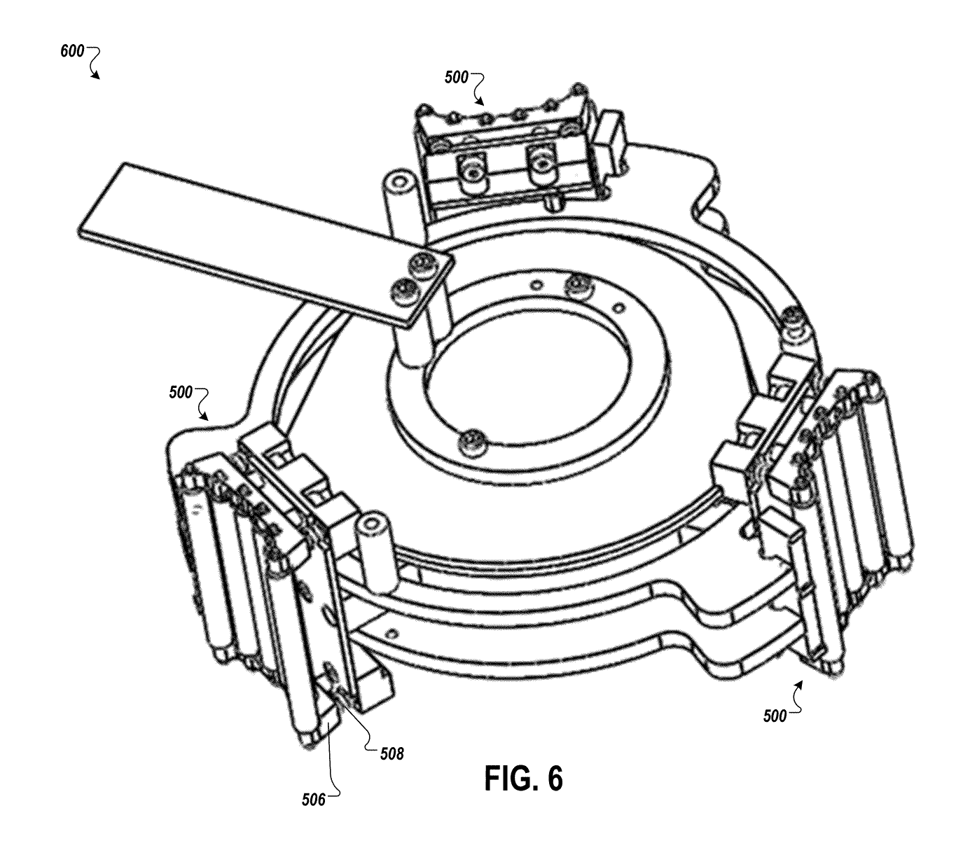

Referring to FIGS. 5 and 6, in some examples, the applicator pallet 52 (shown in

FIG. 1) is configured as a spring-loaded pallet 500. The spring-loaded pallet 500 includes one or more contact rollers 502 (e.g., 1, 2, 3, 4, 5-20 rollers etc.). The contact rollers 502 are spaced apart to allow for their rotation. The contact rollers 502 are attached to a top member 504 and a bottom member 506, which are both connected to a base 512 of the spring-loaded pallet 500 by one or more springs 508. The contact rollers 502 can actuate along a direction generally represented by an arrow 510 as the springs 508 compress and expand.

When the label 21 initially contacts the bottle 20 at the label application station 24, the contact rollers 502 are pushed towards the base 512. The movement compresses the spring 508 thus causing the spring 508 to exert a force that causes the contact rollers 502 to press against the outer surface of the bottle 20 and the label located thereon. This pressure by the contact rollers 502 assists in joining the bottle's outer surface to the label by its activated adhesive.

In some examples, the spring-loaded pallet 500 includes contact rollers 502 which are approximately the height of the soon to be applied label (e.g., have a length equivalent or longer than the label's longest dimension). In this example, the contact rollers 502 perform as generally described above and the similar lengths or a longer length of the contact roller 502 provides contact along the length (e.g., along 99%, 85%, 90%, 80%, 70%, or 60%, of the label) to assist in joining the activated adhesive of the label to the bottle 20.

The application force generated by the spring 508 and exerted against the label 21 is uniform across the surface of the label 21. In other cases, force profile exerted against the label 21 by the spring-loaded pallet 500 is adjustable. For example, the spring members connected to the contact rollers 502 along the outer perimeter of the spring-loaded pallet 500 may be selected to provide more or less force. In this example, the application force is variable by modifying the spring to exert more or less force. In some cases, it may be useful to apply more force through the contact roller along a first edge as compared to remaining edges. In other cases, it may be useful to apply different force profiles along the top edge of the label (e.g., by modifying the springs arranged along the top of the device) relative to a bottom edge. In other cases, it may be useful to different force profiles along the bottom edge of the label relative to the top edge (e.g., by modifying the springs arranged along the bottom edge of the label.

In some examples, the force exerted against the label 21 is adjustable by modifying the direction that the force is applied in. As described above, the one or more contact rollers 502 may actuate along the direction 510. In this case, the direction 510 is generally perpendicular to the base 512. In other examples, the contact rollers 502 may actuate along a direction extending downward (e.g., less than 90° from the base) or extending upward (greater than 90° from the base). In these cases, the force profile is modified based on the direction of travel. For example, the force profile could be 95%, 90%, 80%, 70%, 60%, 50%, 40%, etc. of the force along the perpendicular direction.

The contact rollers are often made of deformable material, such as rubber or foam. As such, the contact rollers may deform in response to the contact of the container with the contact rollers. This deformation may further assist in joining the container outer surface to the label by its activated adhesive. For example, when the amount of tack on the label 21 after the adhesive activation station 54 is reduced relative to the amount of tack traditionally used cold glue or hot melt adhesive, the amount of deformation can be increased to assist in joining the container outer surface to the label by its activated adhesive as well as increasing the level of wraparound of the label to bottle 20. In one example, the contact rollers include are mounted on rigid center pin (e.g., formed of ⅛ inch stainless steel).

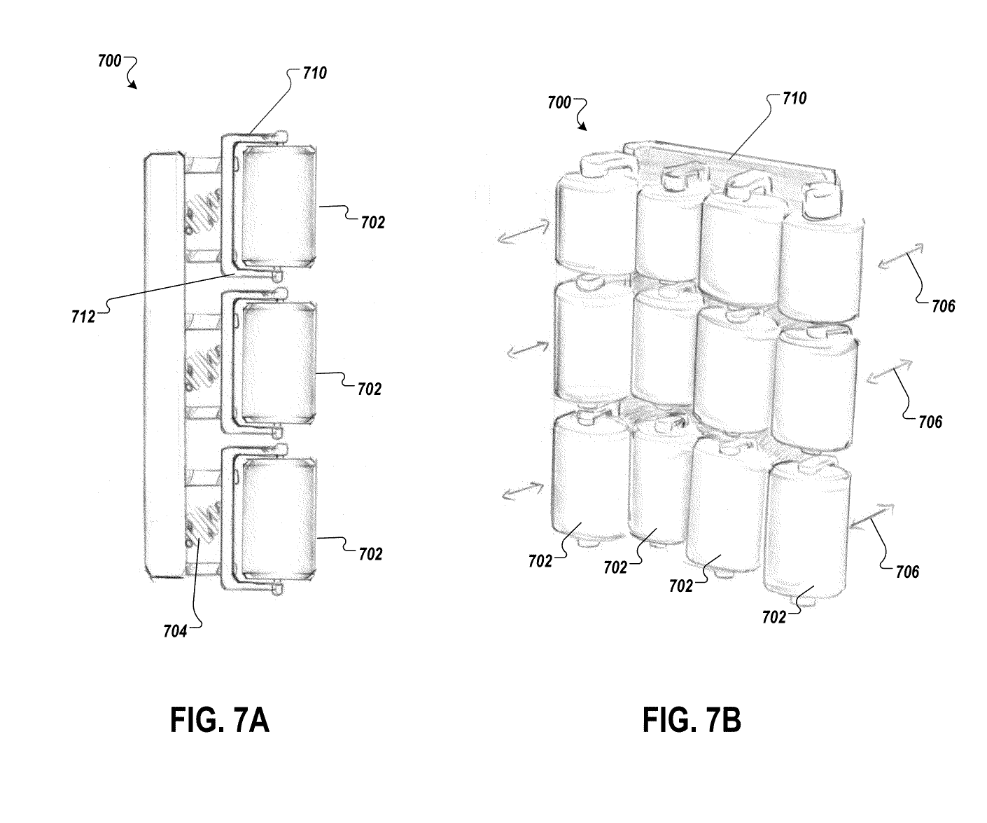

Referring to FIGS. 7A and 7B, in some examples, the applicator pallet 52 (again shown in FIG. 1) is configured as a spring-loaded pallet 700. The spring-loaded pallet 700 includes one or more contact rollers 702 (e.g., 1, 2, 3, 4, 5-20, etc. rollers). In some cases, the number of the contact rollers 702 may be selected based on the size of the label and/or the size of the container. The contact rollers 702 are spaced apart to allow for rotation of the contact rollers 702. In some examples, the one or more contact rollers 702 are attached to a respective top member 712 and a bottom member 710, which are connected to a base 708 of the spring-loaded pallet 700 by one or more spring members 704. The one or more contact rollers 702 actuate along a direction perpendicular to the base 708 and generally represented by an arrow 706 as the springs members 704 compress and elongate. However, as described elsewhere, other directions are contemplated.

In some examples, the spring-loaded pallet 700 includes 6 contact rollers that are 0.375 inch in diameter and 3″ tall to apply a label that is 4 inches wide and 3 inches tall onto a 12 oz. bottle that is 2.4 inches in diameter.

In some examples, the spring loaded pallet 700 includes the contact rollers 702, which are arranged in one or more columns and/or rows, as shown in FIGS. 7A and 7B. Here, as described with respect to the contact rollers 502, the contact roller 702 may be adjustable—for example—by modifying a tunable adjustment member (e.g., the spring member 704, a direction of travel, etc.)

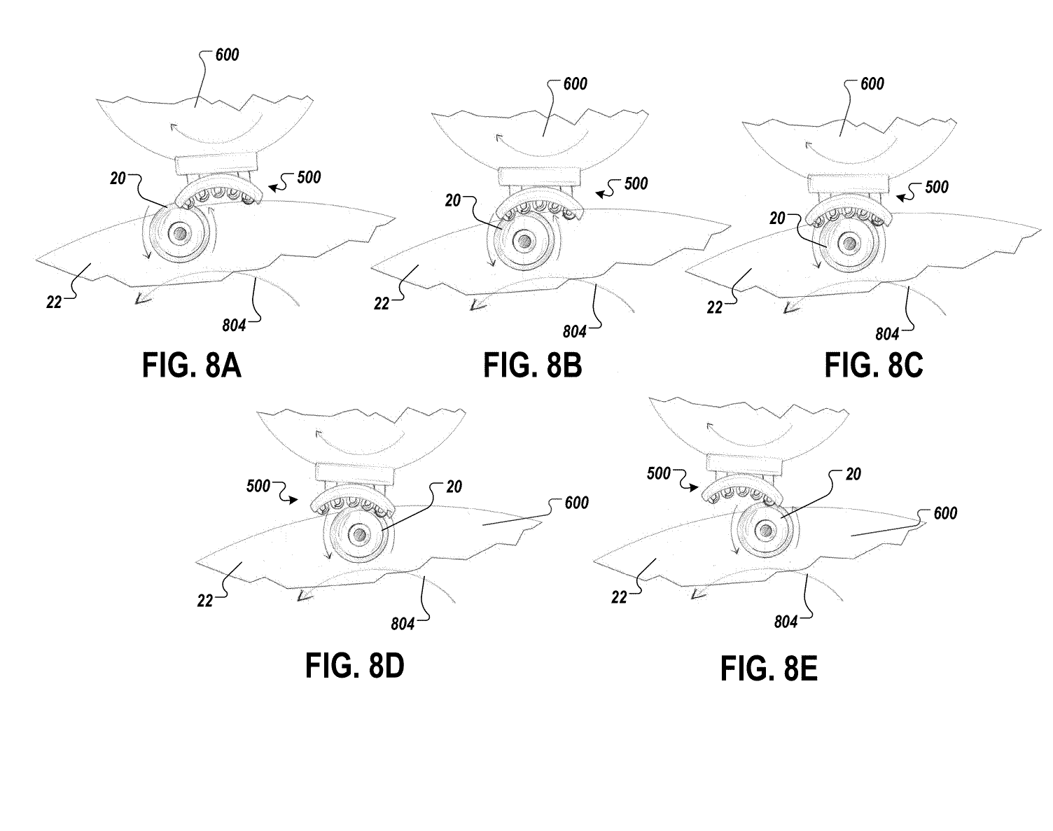

In some cases, the contact rollers 502 are arranged to form an arcuate surface onto which the label and the bottle may be received. For example, referring to FIGS. 6 and 8A-8E, a second rotating member 600 is shown with the spring-loaded pallets 500. The outermost contact rollers are arranged farther away from the base 521 than the innermost contact rollers. As such, the spring-loaded pallet 500 forms an arcuate surface along the contact rollers 502. In some examples, the radius of curvature of this arcuate surface is selected based on the container to be labeled. This may include matching the contour of the container to be labeled such that at least each roller is in contact with or places some force onto the container. In some cases, force can be applied over 20%-75% of the container's surface (e.g., over 75%, 60%, 55%, 50%, 45%, 35%, 25%, 20%, etc.) of the container's surface. This configuration may promote attachment of the activated adhesive layer of label 21 to the outer surface of the bottle 20. For example, during use the contact rollers 502 may each exert at least some force against the label 21 because of the arcuate configuration.

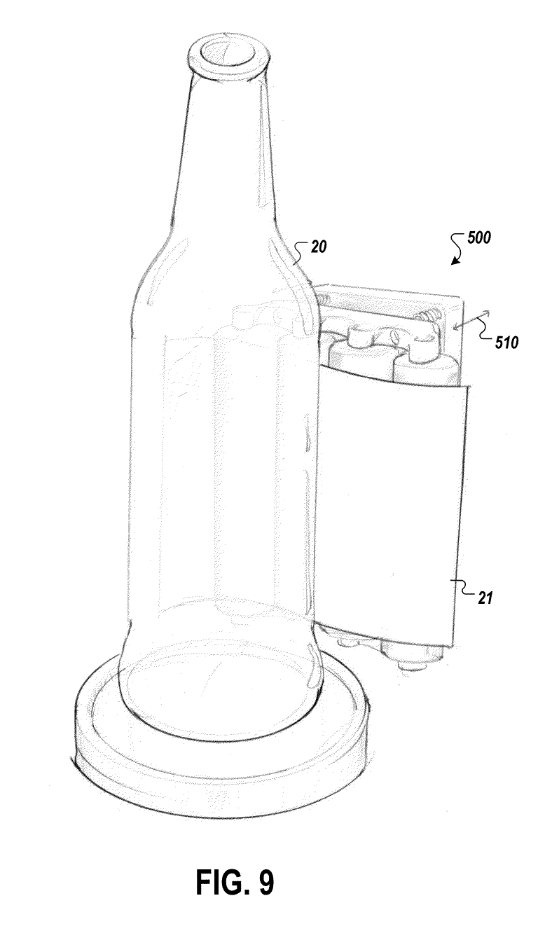

Referring to FIGS. 8A-8E and 9, in some examples, during use, the rotatable transfer member 600 that includes the spring-loaded pallet 500 is rotating clockwise as shown by an arrow 806. The rotating turret or rotatable platform 22 rotates counterclockwise, as shown by an arrow 804 while the bottle 20 also independently rotates counterclockwise as shown by an arrow 802. During use, the spring-loaded pallet 500 may carry and transfer the label 21, however, the label 21 is not shown for clarity in FIGS. 8A-8E for clarity.

In some examples, the linear speed of the transfer member 600, spring loaded pallet 500, and turret or rotatable platform 22 is monitored and controlled (e.g., by one or more sensors and a controller). By monitoring such quantities, one or more operations may be executed. For example, the linear speed of the spring-loaded pallet 500 (and thus the contact rollers 602) can be matched to the linear speed of the bottle 20. This provides a clean transfer when and where the two components contact each other.

As shown in FIG. 8A, the spring-loaded pallet 500 contacts the bottle 20 (e.g., by a first contact roller.) In some examples, the spring-loaded pallet 500 applies the leading edge of the label 21 to the bottle 20 (as shown in FIG. 9). As the components continue to rotate, additional contact rollers come into contact with the bottle 20 (as shown in FIG. 8A) until all contact rollers have contacted the bottle 20 (as shown in FIG. 8C). FIGS. 8D and 8E show the spring-loaded member completing the label application process. In some examples, this final contact includes applying the trailing edge of the label 21 and/or wiping along the label 21.

Referring again to FIG. 1, in some examples, after a label 21 initially is adhered to a bottle 20 in the label application station 24, the rotating turret or rotatable platform 22 directs each bottle (with the label attached thereto) through a series of opposed inner and outer brushes 56. As the bottles are directed through the series of brushes, the bottles are also oscillated back and forth along their central axis, thereby creating an interaction between the bottles, labels and brushes in order to effectively adhere the entire label to the periphery of each bottle.

After the labels 21 have been effectively adhered, the bottles 20 are carried by the rotating turret 22 in the direction of arrow 58 to the bottle-transfer member 18, at which point the bottles are transferred to the outlet conveyor section 14 for subsequent packaging.

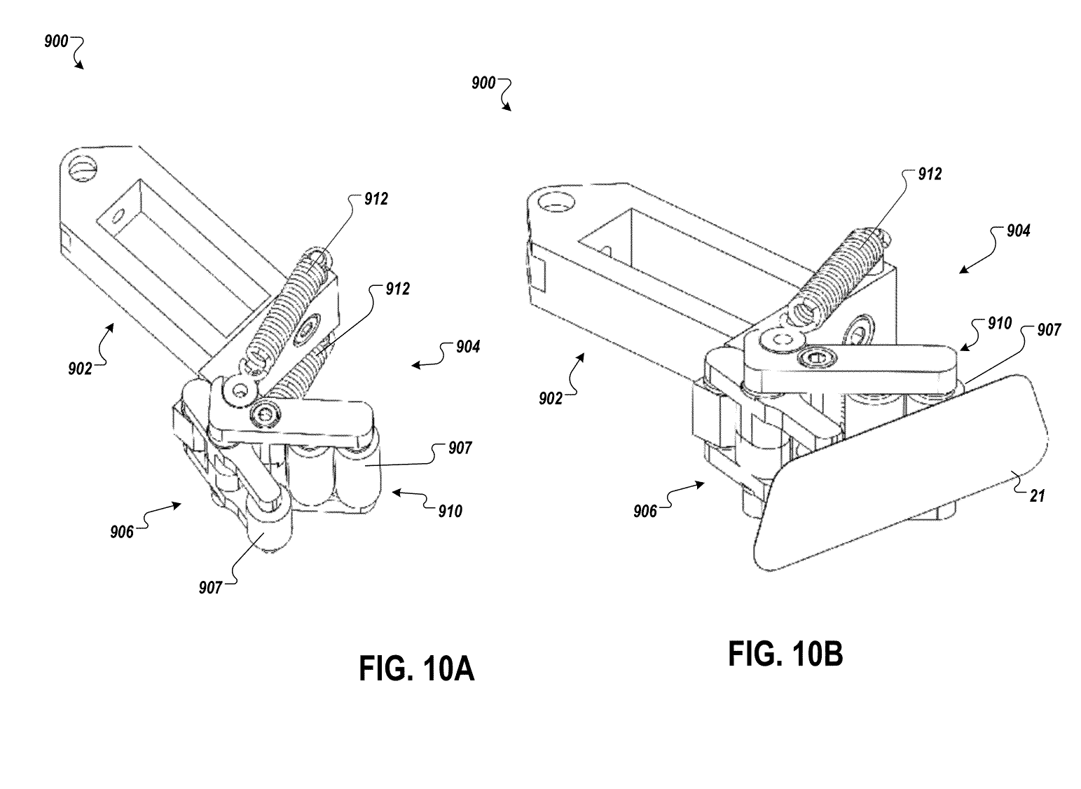

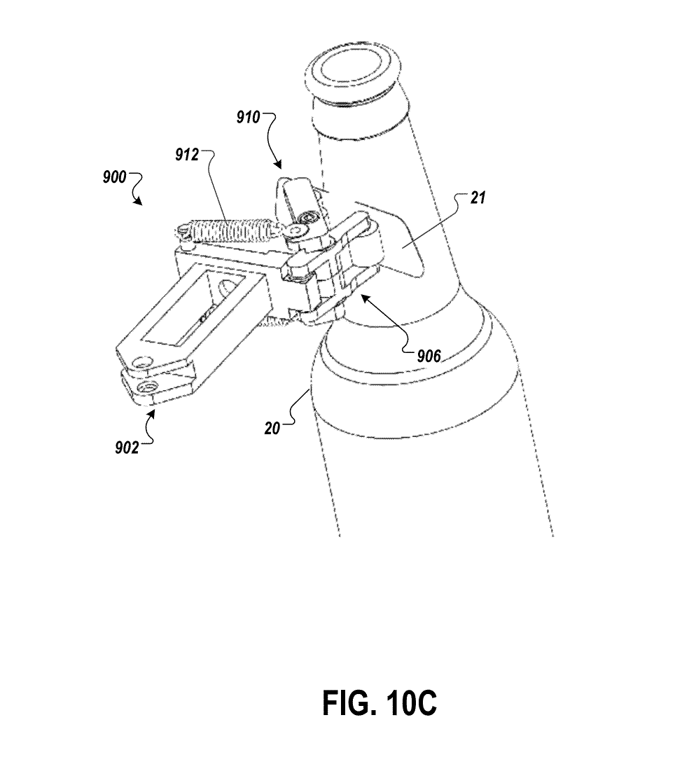

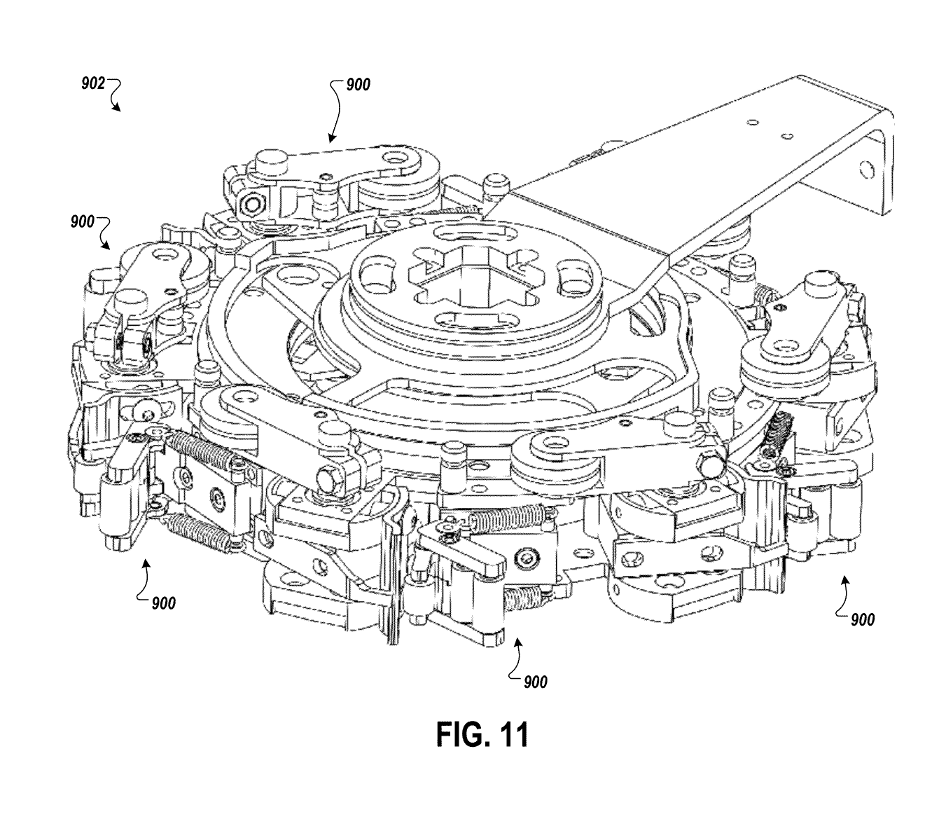

In some examples, a bottle 20 may have a diameter smaller than 2 inches (e.g., between 1 and 1.5 inches in diameter). Referring to FIGS. 10A-10C, a bottle neck applicator 900 is shown. The bottle neck applicator 900 includes a second rotating transfer member 902 and a spring loaded pallet 904. The spring loaded pallet 904 includes a base 908 that is part of the transfer member 902, a first applicator 906, a second applicator 910, a tunable adjustment member (e.g., a spring) 912, and one or more rolling mechanisms 907 mounted to the first applicator 906 and the second applicator 910. The first applicator 906 is mounted to the transfer member with the second applicator mounted to some point on the first applicator 906. The spring 912 is fixed to the second applicator 910 such that it applies a substantial proportion of its return force to the first applicator 906 and a small proportion of its return force to the second applicator 910, thereby imposing an asymmetrical force on the labels 21. The rolling mechanisms 907 are configured to be mounted on a spring-return cam mechanism such that the first applicator 906 is spring-loaded to apply the leading portion of the label 21 to a container while the second applicator 910 is configured to function as a trailing applicator to complete the label application process on bottle 20. The transfer member 902 is shown in FIG. 11, including a plurality of bottle neck applicators 900 and is generally otherwise similar to the transfer member 600 described above.

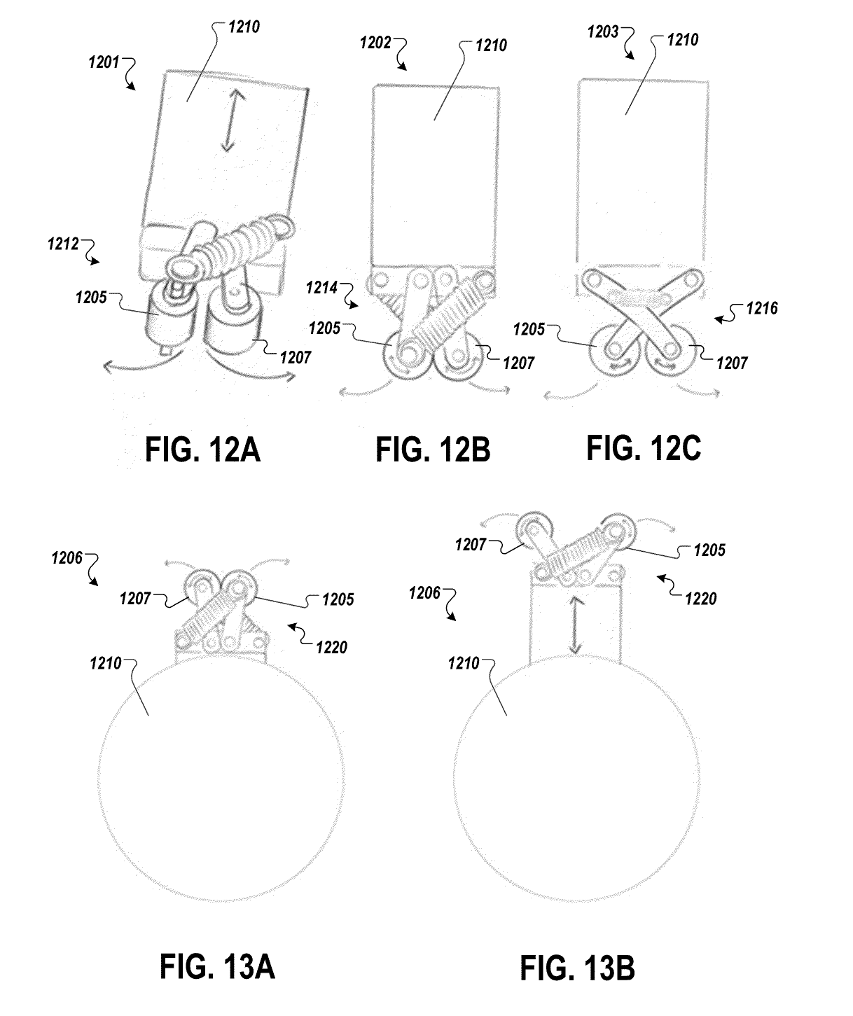

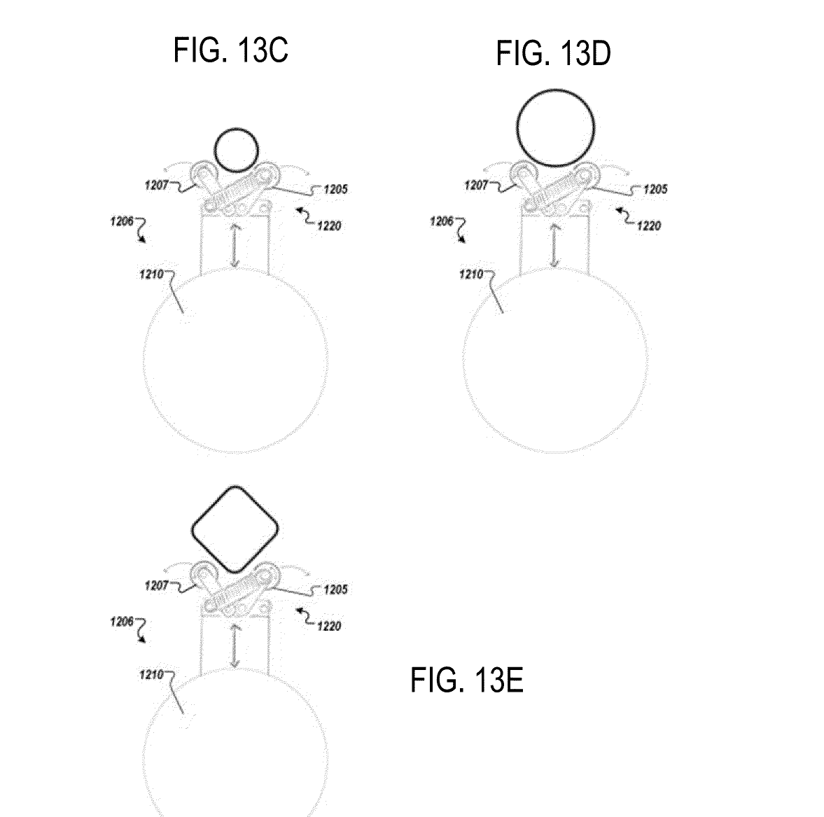

Referring to FIGS. 12A-12C and 13A-13E, another example of a bottle neck applicator 1201-1204, 1206 is shown. In this example, a first applicator 1205 and a second applicator 1207 each include at least one roller and each applicator is connected to the transfer platform 1210. The first applicator and the second applicator 1207 are spring loaded such that each arm their respective rollers are positioned towards the center of the assembly when not in use. During use, the configuration of the applicators 1205, 1207 positions the applicators 1205, 1207 to the rollers contacts the containers, e.g., the bottles 20, containers as the bottles 20 rotate on a second transfer member (as described above), and with linear speed matched between the transfer platform 1203 and the container (as described elsewhere).

The bottle neck applicator 1201-1204, 1206 includes a spring-return cam mechanism that is configured to separate the applicators when contact is made with a container, e.g., the bottle 20. The cam and spring configurations 1212-1220 are also configured to exert an inward force on the rollers due to the restoring force of the spring. This combination of features provides a flexible arrangement compatible with a variety of container shapes. For example, combination of features includes separating applicator motion from an inward force on the rollers so that the rollers may apply labels to a container having a relatively large arc. Various spring and cam configurations are shown in FIGS. 12A-12C. For example, FIG. 12A illustrates a configuration including both a fixed roller and a spring loaded and articulating roller, which provides a combination of features where the label application can have a fixed point of contact in combination with a moving roller to provide a varied force over the length of the label. In another example, FIG. 12B illustrates a configuration with two articulating rollers that are each spring loaded, providing the ability to tune the pressure applied by each roller. In another example, FIG. 12C illustrates a single spring configuration with two articulating rollers where the force applied is split between the two rollers. These different roller configurations provide the ability to apply and wrap the label onto the container during a brief contact period, unlike a traditional application sponge that only makes contact with a container at the apex of their intersection.

Referring to FIGS. 13A-13E, the bottle neck applicator is shown applying a label to a bottle using the applicator as shown in FIG. 12B, which includes two spring loaded articulating rollers. As shown in the FIG. 13A, the rollers 1207, 1205 are disposed towards each other at rest and will separate during the application process (as shown in FIG. 13B). FIGS. 13C-13E show the configuration of FIGS. 13A and 13B adapting to applying a label to a variety of container shapes and sizes. The same configuration is adaptable and compatible with a containers having a variety of container shapes and sizes. In these examples, the same configuration transitions from small circular containers (FIG. 13C) to circular containers having a larger diameter (FIG. 13D) to containers having a rectangular or non-circular shape (FIG. 13E).

### Other Examples

While, in at least some of the examples, the shape of the spring-loaded pallet is generally described as arcuate and contoured to the container, other configurations are contemplated. For example, the spring-loaded pallet may be configured such that the arcuate shape of the contact rollers includes an arc larger than that of the container. Such a configuration could be desirable so that the transfer member could rotate at a faster rate than the container to, for example, facilitate synchronization between the bottle 20 and the spring-loaded pallet so that initial contact occurs at the beginning of the arc.

While, in at least some of the examples, the contact rollers are generally shown as cylindrical, other configurations are contemplated. For example, the contact rollers could have a variable diameter along their length such as a conical shape. Such a configuration would be useful to label bottle necks or conical containers to provide uniform contact along the label. In some cases, the configuration of the contact rollers can be customized relative to a specific container configuration.

This oscillatory motion is provided by a cam drive arrangement. Exemplary cam drive arrangements for rotating a transfer member are known to those skilled in the art. In some examples, a motor (e.g. a servo motor) causes the movement of the rotatable platforms and transfer mechanisms

From the foregoing description, it will be apparent that there has been provided an improvement to an automated labeling machine for use with labels having fluid activatable adhesive. Variations and modifications in the herein described improvement, method, or system with apparatus 10 and liner-free labels 21, will undoubtedly suggest themselves to those skilled in the art. Accordingly, the foregoing description should be taken as illustrative and not in a limiting sense.

What is claimed is:

1. An apparatus for applying labels to containers, said apparatus comprising:
a guidance mechanism configured to provide a path for receiving a plurality of labels having a back surface with a fluid activatable adhesive that is non-tacky until activated, the guidance mechanism including at least one rotatable transfer member having a plurality of pallets, each of the pallets having:
multiple openings for communication of suction to enable at least one of the pallets to receive and releasably secure a front of the labels onto at least one pallet, and
one or more rollers connected to each of the pallets by one or more tunable complaint members;
an adhesive activation station aligned with at least a portion of the guidance mechanism and configured to apply to the back surface of said labels a fluid to activate said adhesive along said back surface of said labels; and
a label application station configured to apply at least one of said labels with said activated adhesive onto an exterior surface of a corresponding object located on a rotatable platform, wherein the label application station includes a servo motor configured to drive a linear speed and a rotational direction of the platform.

2. The apparatus of claim 1, further comprising:
a dispensing magazine for retaining a plurality of individual labels in a stack and a second rotating transfer member arranged in close proximity to individual labels and including at least one pallet thereon, the at least one pallet having multiple openings for communication of suction to enable the second rotating transfer member to receive and releasably secure a front of the labels onto the at least one pallet.

3. The apparatus of claim 2, wherein the second rotating transfer member further comprises one or more valves to selectively control communication of suction to a selected subset of the multiple openings based on a size of the label, each of the valves being associated with a particular one of the multiple openings.

4. The apparatus of claim 1, further comprising:
one or more sensors for sensing the linear speed, the rotational direction, or both the linear speed and rotational direction of the rotatable transfer member and of the rotatable platform; and
a controller configured to control the servo motor in response to the sensors.

5. The apparatus of claim 1, wherein the one or more tunable complaint members is one or more springs.

6. The apparatus of claim 1, wherein the one or more rollers are arranged to form a concave surface on each of the pallets.

7. The apparatus of claim 1, wherein the rotatable platform rotates at a linear first speed and the rotatable transfer member rotates at a linear second speed.

8. The apparatus of claim 1, wherein a length of the one or more rollers at least as long as a longest length of the labels.

9. The apparatus of claim 1, wherein each pallet includes a plurality of rollers connected to each of the pallets by one or more tunable-complaint members, wherein the plurality of rollers are arranged in at least two rows.

10. The apparatus of claim 1, wherein each of the one or more rollers independently connects to the pallets by one or more by one or more tunable-complaint members.

11. The apparatus of claim 1, wherein a force exerted by the one or more by one or more tunable-complaint members is variable.

12. The apparatus of claim 1, further comprising:
a container-handling device for receiving containers at an inlet, rotating the containers on the rotatable platform through the label application station, and directing the containers with the labels applied thereon to an outlet.

13. The apparatus of claim 1, wherein the at least one rotating transfer member further comprises one or more valves, each of the valves being associated with a particular one of the multiple openings, to selectively control communication of suction to a selected subset of the multiple openings based on the size of the label.

14. The apparatus of claim 1, wherein the one or more rollers are configured to apply a force to about 50% of a surface of the label.

15. An apparatus for applying labels to containers, the apparatus comprising:
a guidance mechanism configured to provide a path for receiving a plurality of labels having a back surface with a fluid activatable adhesive that is non-tacky until activated, the guidance mechanism including at least one rotatable transfer member having a plurality of pallets, each of the pallets having:
a first applicator including a first roller mechanism and connected to the transfer member;
a second applicator including a second roller mechanism and connected to the first applicator; and
one or more tunable-complaint members connected to the first applicator, to the second applicator, and to the transfer member;
multiple openings for communication of suction to enable at least one of the pallets to receive and releasably secure a front of the labels onto at least one pallet, and
one or more rollers connected to each of the pallets by one or more by one or more tunable-complaint members;
an adhesive activation station aligned with at least a portion of the guidance mechanism and configured to apply to the back surface of said labels a fluid to activate said adhesive along said back surface of said labels; and
a label application station configured to apply said labels with said activated adhesive onto an exterior surface of a corresponding object located on a rotatable platform, wherein the label application station includes a servo motor configured to drive a linear speed and a rotational direction of the platform.

16. The apparatus of claim 15, further comprising:
a dispensing magazine for retaining a plurality of individual labels in a stack and a second rotating transfer member arranged in close proximity to individual labels and including at least one pallet thereon, the at least one pallet having multiple openings for communication of suction to enable the second rotating transfer member to receive and releasably secure a front of the labels onto the at least one pallet.

17. The apparatus of claim 16, wherein the second rotating transfer member further comprises one or more valves to selectively control communication of suction to a selected subset of the multiple openings based on the size of the label, each of the valves being associated with a particular one of the multiple openings.

18. The apparatus of claim 15, further comprising:
one or more sensors for sensing of the linear speed, the rotational direction, or both the linear speed and rotational direction of the rotatable transfer member and of the rotatable platform; and
a controller configured to control the servo motor in response to the sensors.

19. The apparatus of claim 15, wherein the first applicator is configured to apply a leading edge of the label to the container and the second applicator is configured to remove complete the label application.

20. The apparatus of claim 15, wherein the one or more tunable-complaint members are springs.

21. The apparatus of claim 15, wherein the rotatable platform rotates at a linear first speed and the rotatable transfer member rotates at a linear second speed.

22. The apparatus of claim 15, wherein the force exerted by the one or more by one or more tunable-complaint members is variable between the first applicator and the second applicator.

23. The apparatus of claim 15, further comprising a container-handling device for receiving containers at an inlet, rotating the containers on the rotatable platform through the label application station, and directing the containers with the labels applied thereon to an outlet.

24. The apparatus of claim 15, wherein the at least one rotating transfer member further comprises one or more valves, each of the valves being associated with a particular one of the multiple openings, to selectively control communication of suction to a selected subset of the multiple openings based on the size of the label.

25. The apparatus of claim 15, wherein the one or more rollers are configured to apply a force to about 50% of a surface of the label.

26. The apparatus of claim 15, further comprising a spring-return cam mechanism attached to first roller mechanism and the second roller mechanism.
